(19) United States
(12) Patent Application Publication
(10) Pub. No.: US 2019/0255973 A1
(43) Pub. Date: Aug. 22, 2019

(54) CAR SEAT INSERT AND INFANT CARRIER

(71) Applicant: Lena Shahbandar, Burr Ridge, IL (US)

(72) Inventor: Lena Shahbandar, Burr Ridge, IL (US)

(21) Appl. No.: 16/286,584

(22) Filed: Feb. 26, 2019

Related U.S. Application Data
(63) Continuation-in-part of application No. PCT/US2017/048784, filed on Aug. 26, 2017.
(60) Provisional application No. 62/379,936, filed on Aug. 26, 2016.

(51) Int. Cl. B60N 2/28; A47D 13/02

(52) U.S. Cl. CPC B60N 2/2842; B60N 2/2812; A47D 13/025

(57) ABSTRACT

A soft, fabric-based car seat insert which is also an infant carrier is disclosed herein. The car seat insert includes slits that allow for the car seat harness to secure an infant when unfastened. The insert may also function as an infant carrier when removed from the car seat. When the insert is removed from the car seat, the infant's arms slide out of the unfastened car seat harness, which may preferably remain in the car seat, and the infant is safely lifted in the insert while remaining secured in the insert as the insert is lifted out of the car seat. The infant may be secured in the insert with an infant securing system. The insert may also include bag straps, which may also act as handles. The slits of the insert may then be fastened such that the insert forms an infant carrier.

### CROSS-REFERENCE TO RELATED APPLICATIONS

This application is a continuation-in-part of PCT Patent Application No. PCT/US2017/048784, filed on Aug. 26, 2017, which claims the benefit of and priority to U.S. Provisional Patent Application Ser. No. 62/379,936, filed on Aug. 26, 2016, the disclosures of which are incorporated herein in their entireties by reference.

### BACKGROUND

### Field of the Invention

The present disclosure relates to a car seat insert which is also an infant carrier.

### Description of the Related Art

Back pain is a significant cause of morbidity in the United States and worldwide. In a 2010 study of the global burden of disease, low back pain was found to cause more global disability than any of the other 290 conditions studied (Hoy, D, et al. “The Global Burden of Low Back Pain: Estimates from the Global Burden of Disease 2010 Study,” Ann. Rheum. Dis., March 2014). Back pain is highly prevalent during and after pregnancy, as 49% of women experience back pain at some point during pregnancy (Ostgaard, H. C., et al. “Prevalence of Back Pain in Pregnancy,” Spine, May 1991, 549-52) and approximately 40% of women experience postpartum back pain (Ostgaard, H. C., et al. “Postpartum Low-Back Pain,” Spine, January 1992, 53-5).

This high prevalence of back pain during and after pregnancy may be better understood in view of physiological changes occurring in a woman's body during pregnancy. As the body grows to adjust for the growth of the fetus, abdominal muscles stretch. This often causes a split, or diastasis, in the rectus abdominus. These abdominal muscles are critical to stabilization of the spine. In addition, the ligaments of the lumbar spine and pelvis loosen to allow for safe passage of the baby through the birth canal during birth. This reduces intrinsic spinal stability. Further, the S-shaped curve of the back increases, which puts additional pressure on the lumbar spine. Moreover, the pelvic floor muscles become stretched and often weakened. These muscles function as a crucial floor for the body's core musculature, and this muscular weakening results in a cascade effect that impacts the strength and stability of the spine. Finally, women are now becoming pregnant at older ages and there is a national increase in the rate of pregnancies of multiples (twins, triplets, etc.). As such, the baseline risk for back pain during and after pregnancy is increasing. These factors place women at increased risk for chronic back pain if their problems are not addressed early (see Fitzgerald, C. et al. “The Association Between Pelvic Girdle Pain and Pelvic Floor Muscle Function in Pregnancy,” Int. Urogynecol. 1, July 2012, 893-8; Ritchie, J. “Orthopedic Considerations During Pregnancy,” Clinical ObGYN, June 2003, 456-66). On account of these risk factors, women should be encouraged to minimize activities that increase the risk of back injury during the postpartum period.

While certainly convenient, the use of multi-functional infant car seats that may be removed from a vehicle and function as an infant carrier significantly increases the risk of postpartum back injuries in women. An average infant car seat weighs approximately 15 lbs. and is over 2 feet in length and 18 inches wide. When using a multi-functional infant car seat, parents or other caregivers are tasked with transferring the infant car seat in and out of the car while the infant remains in the car seat.

An evaluation of the physics of lifting demonstrates the significance of these weights and the potential for injury caused thereby. The farther an object is from the center of gravity of a person lifting the object, the more effort is required to lift the object—the moment that a force produces is a multiple of the distance of the object from the center of gravity of the object and the weight of the object. The weight of the infant car seat added to the weight of the infant results in increased pressure through the discs of the spine when this weight is carried further away from the body. Also, a person generally carries an infant car seat in front of or slightly to the side of the body, resulting in increased forces on the intervertebral discs in the anterior compartment of the lumbar spine, and thereby increasing the risk of disc herniation or injury. The spine and abdominal muscles are required to use very high forces to counterbalance the forward forces caused by the weight of an object. These muscles are already weak and stretched in the postpartum period, and thus the risk of injury is increased. Further, the weight of an infant car seat carried on one arm causes increased risk of injury to the carrying arm of a parent. This is in addition to the increased risk of carpal tunnel syndrome and other upper arm maladies from carrying infants without car seats.

Current trends in infant car seat manufacturing are focused on producing car seats with not only increased safety and stability on impact, but also increased versatility and ease of transport. These two considerations are often at odds with one another. Moreover, the very fact that infant car seats are easily removable from vehicles itself increases the risk of danger to infants in a collision. In addition, removability of infant car seats leads to an increased risk of improper installation or improper use. A 2009 study by the National Highway Traffic Safety Administration indicated that 73% of car seats were installed improperly, and nearly 84% of infant car seats were installed improperly (see “Misuse of Child Restraints,” www.nhtsa.gov/About+NHTSA/Traffic+Techs/current/Misuse+Of+Child+Restraints).

There remains a need for an infant car seat or infant car seat insert that reduces the risk of injury in pregnant and postpartum women while also providing both safety and convenience for the infant to be carried therein.

### SUMMARY

A soft, fabric-based car seat insert which is also an infant carrier is disclosed herein. The car seat insert includes slits that allow for the car seat harness to secure an infant when unfastened. The insert may also function as an infant carrier when removed from the car seat. When the insert is removed from the car seat, the infant's arms slide out of the unfastened car seat harness, which may preferably remain in the car seat, and the infant is safely lifted in the insert while remaining secured in the insert as the insert is lifted out of the car seat. The infant may be secured in the insert with an infant securing system, which may include one or more body straps to secure the torso of the infant and a T-strap to secure the bottom and legs of the infant. The insert may also include bag straps, which may act as handles which may be held by an adult. The slits of the insert may then be zippered or otherwise fastened such that the insert forms an infant carrier. The infant carrier may be a handbag-style baby carrier or may alternatively be a front-attaching baby carrier.

### BRIEF DESCRIPTION OF THE DRAWINGS

FIG. 1 shows an inside view of an embodiment of the car seat insert.

FIG. 2 shows a side view of the embodiment shown in FIG. 1.

FIG. 3 shows an embodiment of a detachable pouch accessory.

FIG. 4 shows an embodiment of a head support pillow.

FIG. 5 shows an embodiment of a head support pillow secured to the car seat insert.

FIG. 6 shows an inside view of an embodiment of the disclosed car seat insert in a “canoe” style.

FIG. 7 shows a side view of the embodiment shown in FIG. 6.

FIG. 8 shows an embodiment of a head support pillow secured to the car seat insert in a “canoe” style.

FIG. 9 shows an inside view of an embodiment of the car seat insert.

FIG. 10 shows an outside view of the embodiment shown in FIG. 9.

FIG. 11 shows a side view of the embodiment shown in FIG. 9.

FIG. 12 shows an inside view of an embodiment of the car seat insert.

FIG. 13 shows an inside view of embodiment shown in FIG. 12 with the bag straps not shown.

### DETAILED DESCRIPTION OF ILLUSTRATED EMBODIMENTS

A soft, fabric-based car seat insert which is also an infant carrier is disclosed herein. The car seat insert includes slits that allow for the car seat harness to secure an infant when unfastened. The insert may also function as an infant carrier when removed from the car seat. When the insert is removed from the car seat, the infant's arms slide out of the unfastened car seat harness, which may preferably remain in the car seat, and the infant is safely lifted in the insert while remaining secured in the insert as the insert is lifted out of the car seat. The infant may be secured in the insert with an infant securing system, which may include one or more body straps to secure the torso of the infant and a T-strap to secure the bottom and legs of the infant. The insert may also include bag straps, which may act as handles which may be held by an adult. The slits of the insert may then be zippered or otherwise fastened such that the insert forms an infant carrier. The infant carrier may be a handbag-style baby carrier or may alternatively be a front-attaching baby carrier.

In some embodiments, the car seat insert may include fastener slits that may be fastened and unfastened with a fastener system. The fastener slits may preferably allow for a car seat harness comprising a harness fastener to secure an infant into a car seat when the slits are unfastened. After the harness fastener is unfastened, the insert may be removed from the car seat. When the insert is removed from the car seat, the infant's arms may preferably slide out of the unfastened car seat harness and the harness may preferably remain in the car seat. The infant may thereby be safely lifted in the insert. The insert may further include an infant securing system which may include one or more body straps to secure the torso of the infant as the insert is lifted out of the car seat, wherein the body straps may comprise body strap fasteners to fasten the body straps, and may also further include a T-strap to secure the bottom and legs of the infant, wherein the T-strap may comprise two T-strap fasteners to fasten the T-strap. The insert may also include bag straps, wherein the bag straps may preferably act as handles which may be held by a parent or other caregiver when carrying the insert. After removing the insert from the car seat, the fastener slits of the insert may preferably be fastened such that the insert forms a baby carrier. The baby carrier may be a handbag-style baby carrier or may alternatively be a front-attaching baby carrier.

The car seat insert may be worn as an infant carrier by a parent or other caregiver while an infant remains secured within the insert. Thus the parent or other caregiver does not have to remove the infant from the insert when securing the insert to his or her body to carry the infant in the insert while secured to the parent or caregiver's body. The parent or caregiver may thus reduce the disturbance caused to the infant, such as when the infant is sleeping or tired. The parent or caregiver may in certain situations also not have to remove blankets or other accessories and may thus reduce exposure of the infant to adverse weather conditions when the infant is removed from a car seat in suboptimal weather. In addition, since the infant will already be securely fastened within the insert, the parent or other caregiver will not need to secure the infant within the insert when it is used as an infant carrier. This further reduces the disturbance caused to the infant.

In some preferred embodiments, the bag straps may be secured to the lower end of the main body of the insert in close proximity to each other. A lower bag strap stabilizer may further secure the bag straps to each other and to the lower end of the main body of the insert. As a result, an infant secured in the insert and positioned against a parent or other caregiver's body will automatically assume a position where the infant's hips are in a properly flexed and abducted posture. This may reduce the risk of hip dysplasia in the infant.

In some preferred embodiments, the insert may include exterior handles that may be held by a parent or other caregiver while the parent or other caregiver lifts an infant secured in the insert.

In some preferred embodiments, the insert may include an adjustable waist strap and adjustable back straps which may be used by a parent or other caregiver to secure the insert to his or her body. In some embodiments, the car seat insert may also include a removable lumbar support for the waist strap.

In some embodiments, the insert may further include infant head support stabilizers that stabilize an infant's head when the infant is lifted by an adult or other caregiver while secured in the insert. The infant head support stabilizers may preferably be adjustable to accommodate infants of different sizes and ages. In some embodiments, the infant head support stabilizers may be adjusted using fasteners such as toggle cords and fastener locks such as slotted buttons.

The main body of the insert may additionally comprise a substantially semi-rigid infant support member that may further support the head and torso of an infant and promote configurational integrity of the insert when the infant is lifted by a parent or other caregiver in the insert. This may reduce the risk of hyperflexion or hyperextension of the infant's neck when the infant is lifted by a parent or other caregiver in the insert.

In some embodiments, the fastener system may comprise a zipper. In other embodiments, the fastener system may comprise Velcro. In other embodiments, the fastener system may comprise one or more buttons.

In some embodiments, the car seat insert may further comprise an accessory connector loop and an accessory connector latch, whereby a detachable pouch accessory may be attached to the car seat insert using the accessory connector latch. In some embodiments, the detachable pouch accessory may have pockets on one or both sides.

In some preferred embodiments, the car seat insert may also include a head support pillow.

In some embodiments, the car seat insert may also include a detachable cross strap to facilitate carrying the car seat insert in its infant carrier configuration.

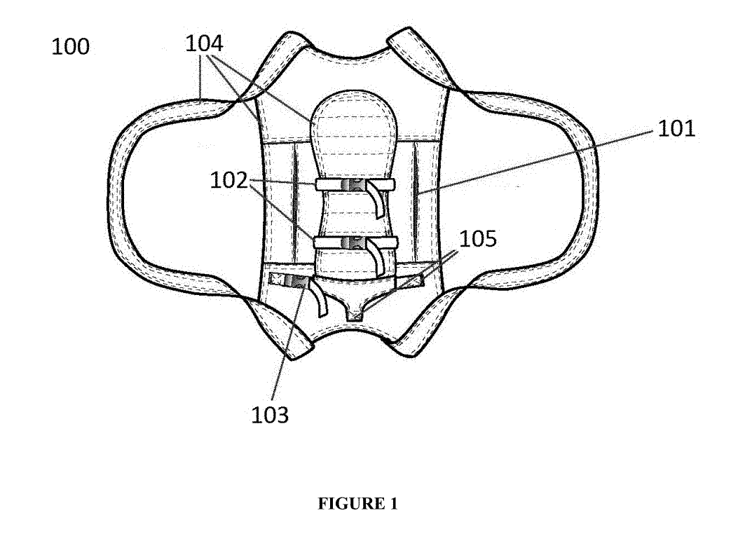

FIG. 1 shows an inside view of an embodiment 100 of the disclosed car seat insert with the body straps fastened, with fastener slits 101, removable body straps 102, an inside bottom adjustable T-strap 103, primary stitching 104, and reinforced secondary stitching 105.

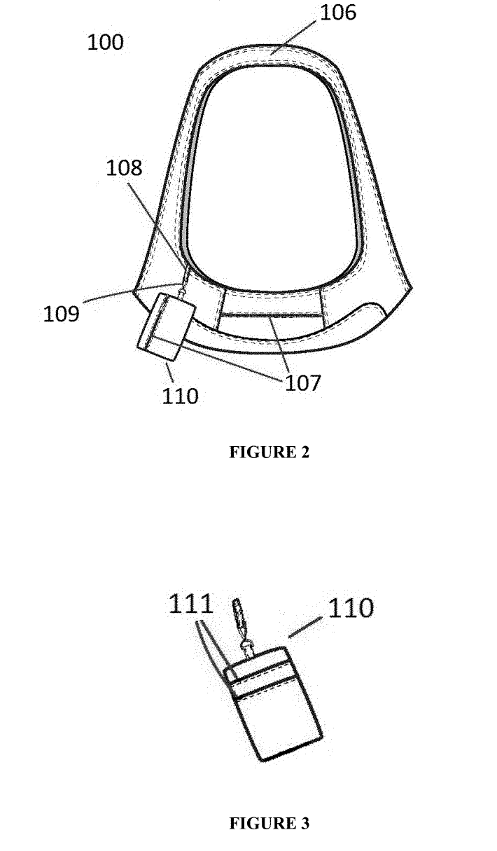

FIG. 2 shows a side view of the embodiment 100 shown in FIG. 1, including bag straps 106, fasteners that are zippers 107, an accessory connector loop 108, an accessory connector latch 109, and a detachable pouch accessory 110. In some embodiments, the zippers may preferably be coil zippers and may also preferably be 7-8 gauge. In some embodiments, the detachable pouch accessory 110 may have pockets 111 on one side, as shown in FIG. 3.

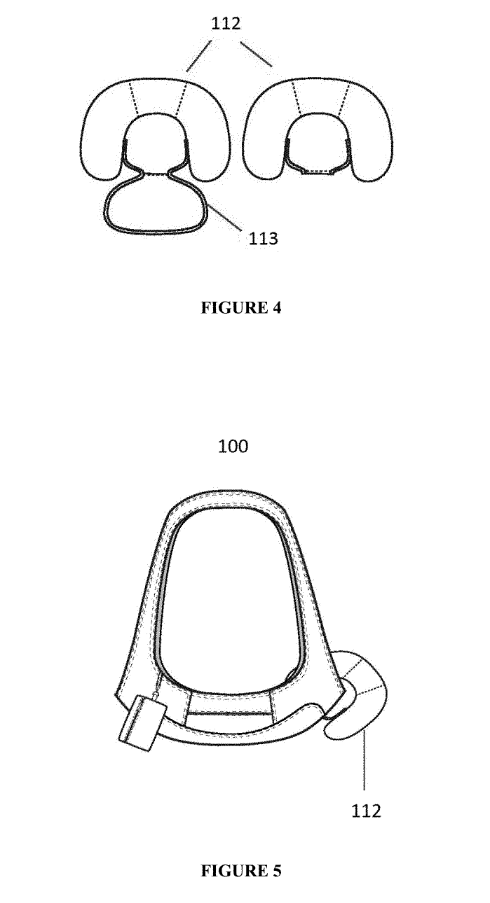

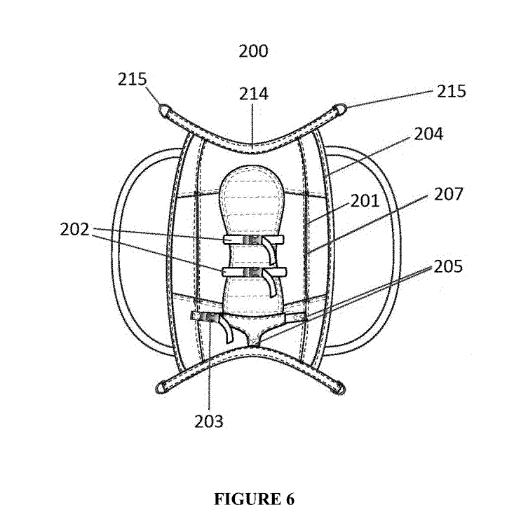

FIG. 4 shows an embodiment of a head support pillow 112. The head support pillow may comprise a binder 113 that may facilitate attachment of the head support pillow to the infant carrier when the infant carrier is placed on the floor. FIG. 5 shows an embodiment of head support pillow 112 secured to car seat insert 100.

FIG. 6 shows an inside view of an embodiment 200 of the disclosed car seat insert in a “canoe” style, with fastener slits 201 and fasteners that are zippers 207, removable body straps 202, an inside bottom adjustable T-strap 203, primary stitching 204, reinforced secondary stitching 205, and D-ring strap 214 with D-rings 215 for securing a detachable cross strap (not shown).

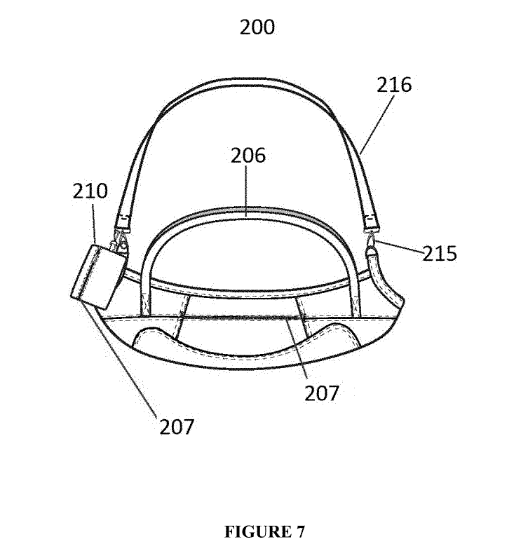

FIG. 7 shows a side view of the embodiment 200 shown in FIG. 6, including bag straps 206, zippers 207, a detachable pouch accessory 210, D-rings 215, and a detachable cross strap 216. In some embodiments, the zippers may preferably be coil zippers and may also preferably be 7-8 gauge.

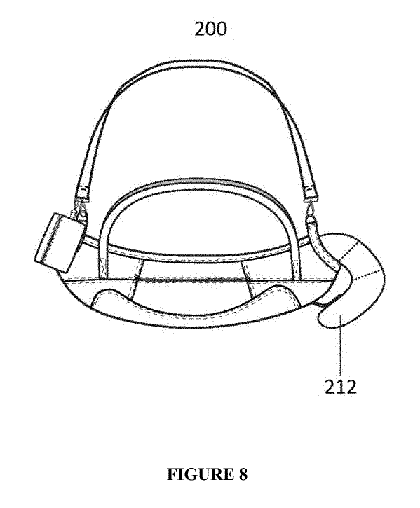

FIG. 8 shows an embodiment of a head support pillow 212 secured to car seat insert 200.

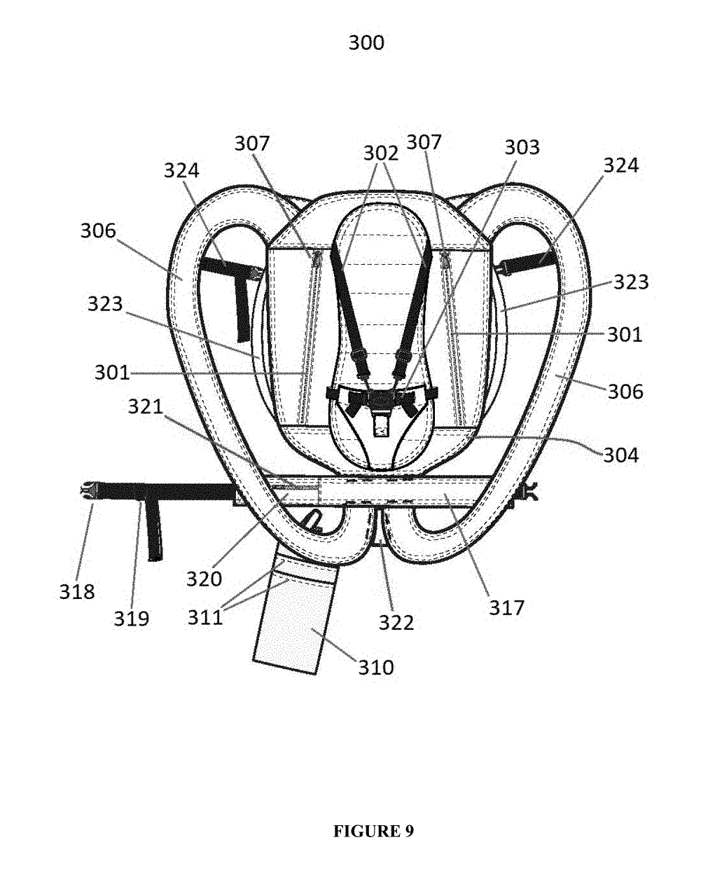

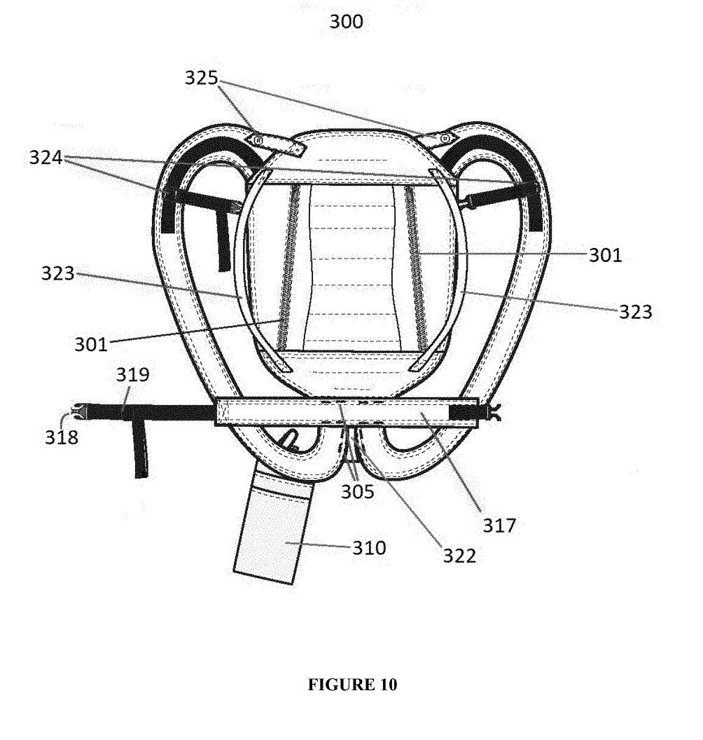

FIG. 9 shows an inside view of an embodiment 300 of the disclosed car seat insert, with fastener slits 301 and fasteners that are zippers 307, body straps 302, an inside bottom adjustable T-strap 303, primary stitching 304, bag straps 306, a detachable pouch accessory 310, a waist strap 317, a waist strap fastener 318, a waist strap fastener adjuster 319, a waist strap pocket 320, a waist strap pocket fastener 321, a lower bag strap stabilizer 322, exterior handles 323, and adjustable back straps 324. In some embodiments, the zippers may preferably be coil zippers and may also preferably be 7-8 gauge. In some embodiments, the detachable pouch accessory 310 may have pockets 311 on one side.

FIG. 10 shows an outside view of the embodiment 300 shown in FIG. 9, with fastener slits 301, bag straps 306, a detachable pouch accessory 310, a waist strap 317, a waist strap fastener 318, a waist strap fastener adjuster 319, a waist strap pocket 320, a waist strap pocket fastener 321, a lower bag strap stabilizer 322, exterior handles 323, and adjustable back straps 324, and infant head support stabilizers 325.

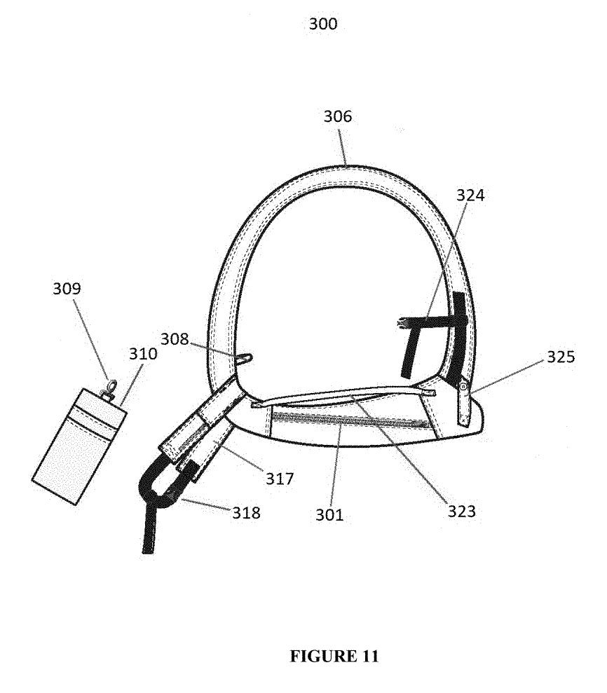

FIG. 11 shows a side view of the embodiment 300 shown in FIG. 9, with fastener slits 301, bag straps 306, an accessory connector loop 308, an accessory connector latch 309, a detachable pouch accessory 310, a waist strap 317, a waist strap fastener 318, exterior handles 323, and adjustable back straps 324, and infant head support stabilizers 325.

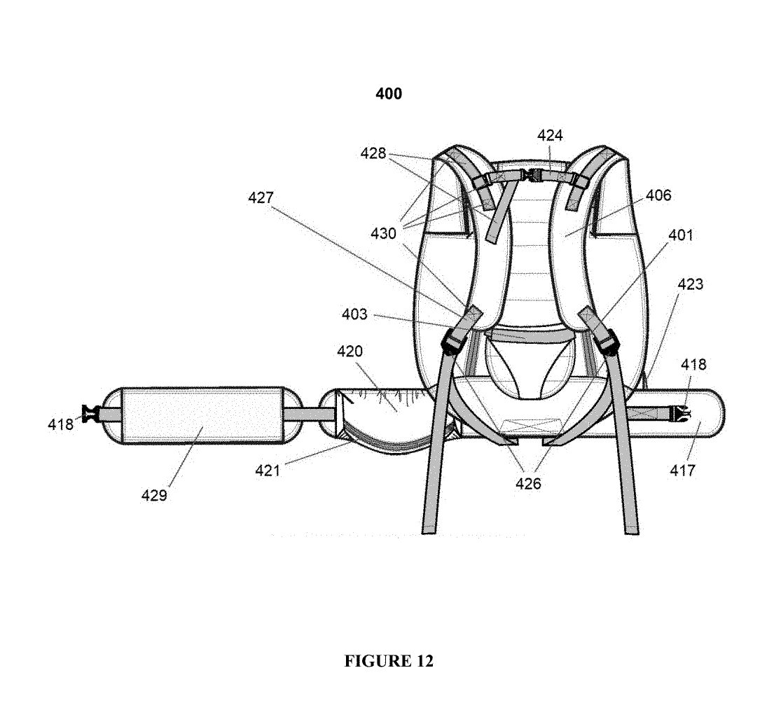

FIG. 12 shows an inside view of an embodiment 400 of the disclosed car seat insert with the body straps fastened, with fastener slits 401, an inside bottom adjustable T-strap 403, bag straps 406, a waist strap 417, a waist strap fastener 418, a waist strap pocket 420, a waist strap pocket fastener 421, exterior handles 423, an adjustable back strap 424, bag strap adjusters 426, bag strap connectors 427, back strap adjusters 428, a removable lumbar support 429, and reinforced secondary box stitching 430.

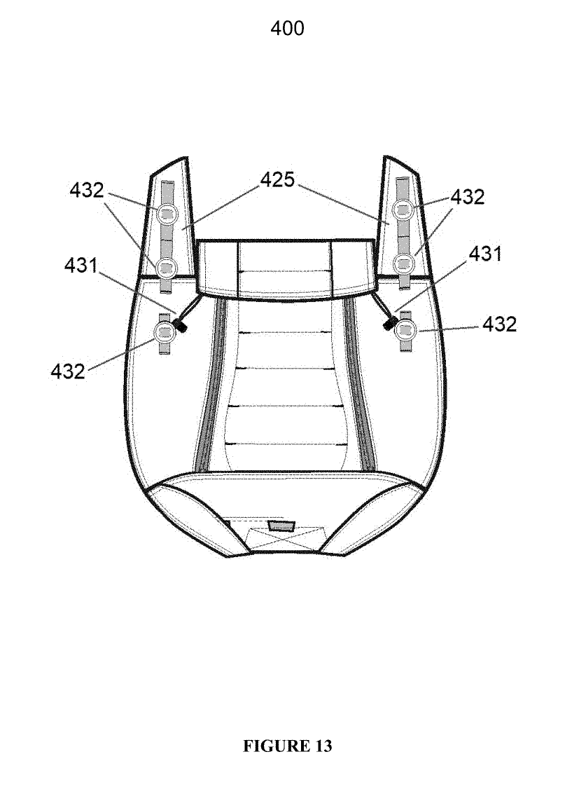

FIG. 13 shows an inside view of embodiment 400 with the bag straps not shown, including infant head support stabilizers 425, infant head support stabilizer fasteners 431, and infant head support stabilizer fastener locks 432.

In some embodiments, a detachable pouch accessory may be provided with embodiment 400.

The insert is configured to readily be inserted into and removed from an infant car seat. In some embodiments, the insert may be directly secured into an infant car seat using the harness system of the infant car seat.

The disclosed infant car seat insert addresses the aforementioned inherent ergonomic disadvantages of carrying an infant car seat. The disclosed insert is a single function, easy-to-use car seat insert intended for transfer of infants in and out of car seats. By trending away from current industry focus on multi-functionality, the disclosed infant car seat insert allows manufacturers of infant car seats to focus on safety features and deemphasize overall product weight because of the separation of the car seat and baby carrier functions.

The weight of the disclosed insert is minimal, allowing a parent or other caregiver to transfer an infant without the additional significant weight and bulk of the infant car seat. Since the disclosed insert is soft and flexible, it conforms more easily to the body of the parent or other caregiver carrying the infant and allows the parent or other caregiver to transport the infant closer to the body and in a more natural position, mimicking traditional infant carriers. In addition, the disclosed car seat insert increases the ease of infant transfer between the car seat and other infant products or desired locations such as strollers, cribs, or other products or locations that may be situated a reasonably short distance from the infant car seat.

The previous description of the disclosed embodiments is provided to enable any person skilled in the art to make or use the invention disclosed herein. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. All references cited herein are expressly incorporated by reference.

What is claimed is:

1. A car seat insert that is also an infant carrier comprising:
a. fastener slits that enable the insert to be reversibly secured to a car seat;
b. an infant securing system; and
c. bag straps.
